(19) United States
(12) Patent Application Publication
(10) Pub. No.: US 2017/0072865 A1
(43) Pub. Date: Mar. 16, 2017

(54) Expandable Roof Rack System

(71) Applicant: Eric Allen Pagel, Fort Collins, CO (US)

(72) Inventor: Eric Allen Pagel, Fort Collins, CO (US)

(21) Appl. No.: 14/851,528

(22) Filed: Sep. 11, 2015

(51) Int. Cl. B60R 9/045

(52) U.S. Cl. CPC B60R 9/045

(57) ABSTRACT

A modular roof rack system which attaches to a vehicles body and/or frame which can either lay flat spanning the vehicle's roof or be extended vertically to accommodate luggage. When not expanded the vehicle will maintain a lower overall height facilitating the ability to be parked in garages, parking structures, as well as emitting less noise while the vehicle is in motion. When the rack needs to be expanded a cam tension bolt on each corner of the rack will be loosened allowing the inner portion of the rack to pivotally extend vertically. Once the rack is deployed said cam tension bolts will be tightened securing the now expanded rack into a deployed position.

### BACKGROUND OF THE INVENTION

Many of the off-road vehicle roof racks being sold on the market today involve a two piece design where a basket must be purchased in addition to a vehicle roof rack. Generally speaking most off-road roof racks that mount to a vehicle consist of tubing which runs parallel to the vehicle and includes bars perpendicular to those to complete a roof rack. Additionally a cargo basket must be fastened to said roof rack for the ability to carry cargo, and removed when not in use. This is a hassle if you park the vehicle in parking structures with low overhead clearance, and minimizes the opportunity to utilize a cargo basket in daily travel.

Typical of prior art patents showing such systems, is U.S. Pat. No. 3,901,422 issued Aug. 26, 1975. In that patent entitled Folding Car Top Carrier, the device appears to move between a load carrying position and a folded position by use of a number of sliding, telescopically arranged tubular members. In addition U.S. Pat. No. 7,798,381 issued Sep. 21, 2010. In that patent entitled Collapsible Roof Basket Carrier, the device appears to attach to the roof of a vehicle and utilizes a clamping mechanism to deploy a cargo basket. However it does not extend from a generally flat position, and offers limited heavy load support.

It would be advantageous to have a cargo system which does not utilize telescoping sliding tubular members as this increases the potential for accumulation of debris, and moisture inside the sliding tubular members resulting in a failure of the mechanism. Additionally advantageous would be the ability to carry heavier cargo either in the lowered position or the extended position across the entire span of vehicle's roof utilizing more rigid mounting locations on the vehicle's body and framework with a singular roof rack system.

### BRIEF DESCRIPTION OF THE DRAWINGS

A better understanding of the invention may be obtained from reviewing the attached drawings which illustrate one embodiment in accordance with the invention, and in which:

FIG. 1 is a perspective view of a vehicle having a roof rack in accordance with the invention, showing the roof rack in the deployed position;

FIG. 2 is a view similar to FIG. 1 showing the roof rack in the flat position;

FIG. 3 is a planar sectional view along section line A-A of FIG. 1;

FIG. 4 is sectional view showing the rotation of the hinges along section line B-B of FIG. 1;

FIG. 5 is a bottom view showing the attachment of the cross bars to the lower platform.

### DETAILED DESCRIPTION OF THE INVENTION

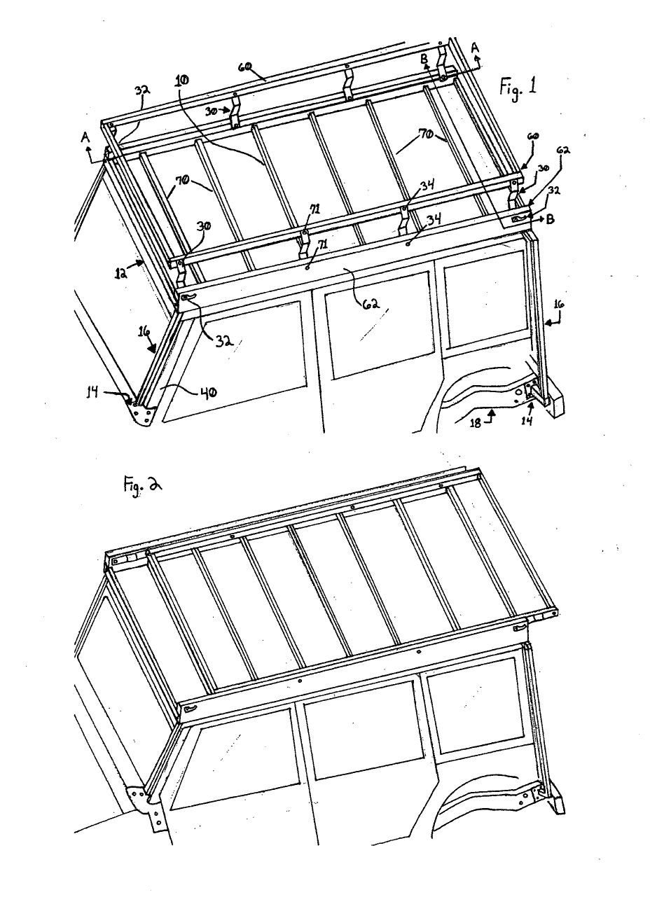

With reference to FIG. 1, the roof rack 10 is illustrated mounted on a vehicle 12. The vehicle 12 includes a vehicle body 40, and vehicle frame 18. The mounting risers 16 attach to locations on the vehicle body 40, and/or the vehicle frame 18 utilizing the mounting brackets 14. The lower platform 62 and upper frame 60 is attached to the mounting risers 16 utilizing assembly bolts 71. The lower platform 62 and upper frame 60 individually form a rectangular shape by attaching the front, back, left, and right sides with assembly bolts 71. The lower platform 62 and upper frame 60 may comprise of a singular design without need for assembly bolts 71.

FIG. 2 shows the same components of FIG. 1 however in the flat position.

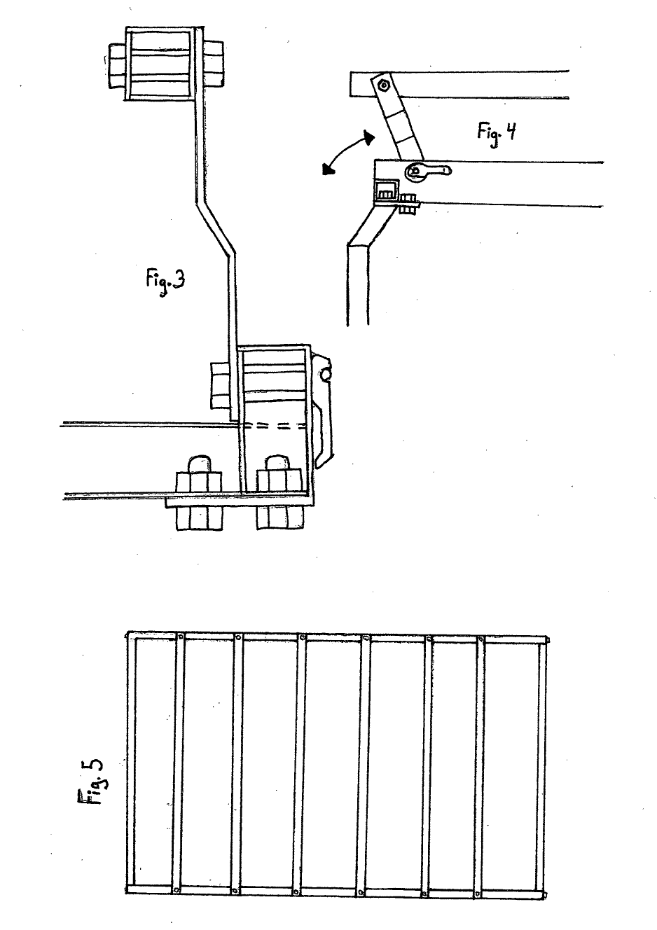

Further with respect to FIG. 1, the roof rack 10 includes a plurality of crossbars 70 which are attached to the lower platform 62 utilizing assembly bolts 71 to complete the tray area, please reference FIG. 5. Also attached to the lower platform 62 are the hinges 30 along the rack in a plurality of locations. The locations on the lower platform 62 for the hinges 30 will include nylon inserts 34 which will allow the assembly bolts 71 to rotate within the lower platform 62. The hinges will also connect to the upper frame 60 in a plurality of locations also including nylon inserts 34, and assembly bolts 71. The roof rack 10 will also include a plurality of cam locks 32 allowing the upper frame 60 to be deployed from a secured flat position within the lower platform 62, additionally the cam locks 32 will secure the upper frame 60 in the deployed position.

FIG. 3 illustrates the hinges 30 connecting to the lower platform 62 and upper frame 60 utilizing the nylon inserts 34, assembly bolts 71, and cam locks 32 to form the general mechanism for the roof rack's 10 function. Note the cam locks 32 remain stationary in the locations on the lower platform 62.

FIG. 4 illustrates the movement of the hinges 30 and upper frame 60 when being deployed or flat. FIG. 4 also illustrates the mounting risers 16 attaching to the lower platform 62 in locations on the front, back, right, and left sides with assembly bolts 71.

With respect to FIG. 1, the roof rack 10 will comprise of metal components in general, although thermoplastic may also be utilized for components. Roof rack 10 may also utilize a thermoplastic or metal wind deflector that can be deployed in front of the upper frame 60 and lower platform 62.

Although the invention has been shown and described by reference to embodiments in accordance with the invention, the invention is not limited to these specific embodiments. Other variations and substantial differences may be apparent to those of ordinary skill in this art. All such variations and changes are considered to be within the scope of the invention as set out in the preceding claims.

The invention claimed is:

1. A vehicle roof rack system made from steel rectangular, square, or circular tubing, which secures to the vehicle body and/or framework; wherein: said roof rack will sit externally above the vehicle; said roof rack will be expandable from a flat position when mounted on said vehicle; and an extended position on said vehicle; said roof rack including vertical mounts which extend down the body for attachment to the vehicle, a lower platform and an upper attached frame; said platform and upper frame being generally parallel to one another in both the flat position and the extended position; said lower platform having left and right sides as well as front and back forming a rectangular shape; said lower platform includes a plurality of load support bars spanning from right side to left side; said upper frame having left and right sides as well as front and back forming a rectangular shape; said lower platform and upper frame will be permanently connected in a plurality of pivoting locations; said pivoting locations will consist of steel hinges and rotate from a horizontal position to a vertical position generally being fastened by a bolt and nylon insert; said steel hinges may come in varying lengths; said pivoting locations include a cam tension bolt located along the side of the roof rack in the forward most pivot and rear most pivot; said cam tension bolts may be included in other locations on the lower platform as well; said cam tension bolts will allow the upper frame to be secured within the lower platform to form a low profile roof rack and can be loosened to allow the upper frame to extend from inside the lower frame then being tightened to accommodate more storage area.
